(19) United States
(12) Patent Application Publication
(10) Pub. No.: US 2019/0059121 A1
(43) Pub. Date: Feb. 21, 2019

(54) USER DEVICE AND COMMUNICATION METHOD

(71) Applicant: NTT DOCOMO, INC., Tokyo (JP)

(72) Inventors: Shinya Takeda, Tokyo (JP); Wuri Andarmawanti Hapsari, Tokyo (JP)

(73) Assignee: NTT DOCOMO, INC., Tokyo (JP)

(21) Appl. No.: 16/074,451

(22) PCT Filed: Nov. 4, 2016
(86) PCT No.: PCT/JP2016/082788

§ 371 Date: Aug. 1, 2018

(30) Foreign Application Priority Data
Feb. 9, 2016 (JP) 2016-022798

(51) Int. Cl. H04W 76/10; H04W 4/90

(52) U.S. Cl. CPC H04W 76/10; H04W 84/042; H04W 4/90

(57) ABSTRACT

A user device communicating with a base station includes a determiner that determines whether the user device is set at low access priority and whether data to be transmitted to the base station is high-priority data, and a transmitter that transmits an RRC message to the base station. When the user device is set at low access priority and the data to be transmitted to the base station is the high-priority data, the determiner reports, to the transmitter, information indicating transmission of the high-priority data, and the transmitter sets the information indicating the transmission of the high-priority data in the RRC message, and transmits the RRC message to the base station.

### TECHNICAL FIELD

The present invention relates to a user device and a communication method.

### BACKGROUND ART

In the Universal Mobile Telecommunications System (UMTS) network, Long Term Evolution (LTE) has been standardized with an aim to achieve higher data rate and lower delay (Non-Patent Document 1). Also, to improve LTE in terms of broadband and high-speed communications, successor systems to LTE (e.g., LTE-Advanced (LTE-A), Future Radio Access (FRA), 4G, and 5G) are being considered.

With the decreasing costs of communication apparatuses, the development of technologies for machine-to-machine (M2M) communication, where apparatuses connected to a network communicate with each other and automatically perform control processes without the intervention of humans, is being actively conducted. Particularly, the Third Generation Partnership Project (3GPP) is in the process of standardizing technologies for optimization of Machine Type Communication (MTC) that is a cellular system for M2M communication (Non-Patent Document 2). In the standardization process, functions required for an MTC terminal used for MTC are also being considered. For example, an MTC terminal whose communication bandwidth is limited to reduce costs is being considered.

More specifically, 3GPP Release 13 discusses an MTC terminal called category M whose operating frequency band is limited to 1.4 MHz and an MTC terminal in a category called Narrow Band—Internet of Things (NB-IoT) whose operating frequency band is limited to 180 kHz or lower to further reduce the costs. Also, in addition to achieving a low-cost MTC terminal, a communication system called Cellular IoT (CIoT) is being considered to achieve a network architecture including a core network with low costs (Non-Patent Document 1).

It is being considered to use the MTC terminal (MTC UE (user equipment)) for a wide range of fields such as an electric meter, a gas meter, a vending machine, a vehicle, and other industrial machines.

### RELATED-ART DOCUMENTS

### Non-Patent Documents

[Non-Patent Document 1] 3GPP TR23.720 V1.2.0 (2015-11)
[Non-Patent Document 2] 3GPP TS36.331 V13.0.0 (2015-12)
[Non-Patent Document 3] 3GPP TS24.301 V13.4.0 (2015-12)

### DISCLOSURE OF INVENTION

### Problems to be Solved by the Invention

A radio communication system conforming to the 3GPP standards employs a restriction control scheme to reduce an increase in the load of a network due to the simultaneous access by many user devices. In the restriction control scheme, a base station identifies the type of an RRC connection request received from a user device and denies the acceptance of the RRC connection request depending on the load of the network.

In the restriction control scheme, the base station determines whether to accept an RRC connection request based on an establishment cause set in the RRC connection request. In the current specification of LTE, an establishment cause called “delayTolerant” is defined for the MTC terminal whose priority is lower than that of normal terminals. The base station more severely restrict RRC connection requests with an establishment cause “delayTolerant” than RRC connection requests with other establishment causes.

Here, with the advancement of M2M communication technologies, it is expected that even an MTC terminal with low access priority performs an important communication with priority higher than the priority of communications performed by normal user devices. For example, a gas detector may be provided for a gas meter having a communication function so that a gas leak can be automatically detected and automatically reported to a gas company.

However, with the current LTE, because the establishment cause “delayTolerant” is set for the MTC terminal with low access priority, the base station cannot detect that high-priority data is to be transmitted from the MTC terminal. Accordingly, when the load of the base station is high, the MTC terminal may not be able to establish an RRC connection and transmit high-priority data.

One object of this disclosure is to solve or reduce the above-described problems, and to provide a technology that enables even a user device with low access priority to transmit high-priority data.

### Means for Solving the Problems

An aspect of this disclosure provides a user device communicating with a base station. The user device includes a determiner that determines whether the user device is set at low access priority and whether data to be transmitted to the base station is high-priority data, and a transmitter that transmits an RRC message to the base station. When the user device is set at low access priority and the data to be transmitted to the base station is the high-priority data, the determiner reports, to the transmitter, information indicating transmission of the high-priority data, and the transmitter sets the information indicating the transmission of the high-priority data in the RRC message, and transmits the RRC message to the base station.

### Advantageous Effect of the Invention

An aspect of this disclosure provides a technology that enables even a user device with low access priority to transmit high-priority data.

### BRIEF DESCRIPTION OF THE DRAWINGS

FIG. 1 is a drawing illustrating an example of a configuration of a radio communication system according to an embodiment;

FIG. 2 is a sequence chart illustrating a process performed by a radio communication system according to an embodiment;

FIG. 3 is a drawing illustrating an example of a functional configuration of a user device according to an embodiment;

FIG. 4 is a drawing illustrating an example of a functional configuration of a base station according to an embodiment;

FIG. 5 is a drawing illustrating an example of a hardware configuration of a user device according to an embodiment;

FIG. 6 is a drawing illustrating an example of a hardware configuration of a base station according to an embodiment;

FIG. 7 is a flowchart illustrating a process (1);

FIG. 8 is a flowchart illustrating a variation of the process (1);

FIG. 9 is a flowchart illustrating a process (2);

FIG. 10 is a flowchart illustrating a variation of the process (2);

FIG. 11 is a flowchart illustrating a process (3); and

FIG. 12 is a flowchart illustrating a variation of the process (3).

### DESCRIPTION OF EMBODIMENTS

Embodiments of the present invention are described below with reference to the accompanying drawings. Embodiments described below are examples, and the present invention is not limited to those embodiments. For example, although it is assumed that a radio communication system according to the embodiments conforms to LTE, the present invention is not limited to LTE and may also be applied to other types of systems.

In the specification and the claims of the present application, “LTE” is used in a broad sense and may indicate not only a communication system corresponding to 3GPP release 8 or 9, but also a fifth-generation communication system corresponding to 3GPP release 10, 11, 12, 13, 14, or later.

### ESTABLISHMENT CAUSES

First, establishment causes defined in the current LTE are described. In the current LTE, the following six establishment causes are defined: “emergency”, “highPriorityAccess”, “mt-Access”, “mo-Signalling”, “mo-Data”, and “delayTolerantAccess”.

A user device UE determines an establishment cause to be set in an RRC connection request based on, for example, NAS procedures performed in a NAS layer.

Specific procedures for determining an establishment cause to be set in an RRC connection request are defined for each NAS procedure (Attach, TrackingAreaUpdate, Detach, ServiceReqest) in Table D.1.1 in Non-Patent Document 3.

For example, when the user device UE is to transmit a message such as an Attach Request message other than a call, “mo-Signalling” is set as the establishment cause. Also, when the user device UE is to perform a call process for an emergency call, “emergency” is set as the establishment cause. Also, when a user device UE with low access priority is to perform a call, “delayTolerantAccess” is set as the establishment cause. Also, when the user device UE is to transmit a service request to a base station eNB to perform packet transmission (including VoLTE), “mo-Data” is set as the establishment cause. Also, when the user device UE is to transmit a service request to the base station eNB to respond to a paging message where a CN domain indicator is set in PS, “mt-Access” is set as the establishment cause. Also, when the access class of the user device UE is between 11 and 15, “highPriorityAccess” is set as the establishment cause regardless of the NAS procedure.

In the descriptions below, “existing establishment cause” indicates one of the six establishment causes that is determined according to the above-described procedures defined in Patent Document 3.

### SYSTEM CONFIGURATION

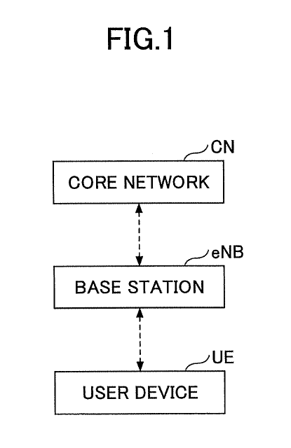

FIG. 1 is a drawing illustrating an example of a configuration of a radio communication system according to an embodiment. The radio communication system of the present embodiment is an LTE radio communication system and includes a user device UE, a base station eNB, and a core network CN. Although only one user device UE and one base station eNB are illustrated in FIG. 1, the radio communication system may include two or more user devices UE and two or more base stations eNB.

The base station eNB wirelessly communicates with the user device UE. Also, the base station eNB relays NAS messages transmitted and received between the user device UE and the core network CN.

The user device UE includes a function to wirelessly communicate with the base station eNB and the core network CN. Although it is assumed that the user device UE is an MTC terminal, the user device UE may also be any other type of device including a communication function.

Also, although it is assumed that the user device UE of the present embodiment is set at low access priority, this is not essential. As described later, the present embodiment may also be applied to a user device UE that is not set at low access priority. Also, a predetermined access point name (APN) is preset as a communication destination in an internal memory or a USIM of the user device UE, and the user device UE transmits data to the predetermined APN. Also, a setting indicating whether the predetermined APN is set at low access priority may be provided. When the APN is not set at low access priority, the user device UE can operate in a manner similar to a normal user device UE even when the user device UE itself is set at low access priority (i.e., the user device UE can operate as if it is not set at low access priority).

### PROCESS OUTLINE

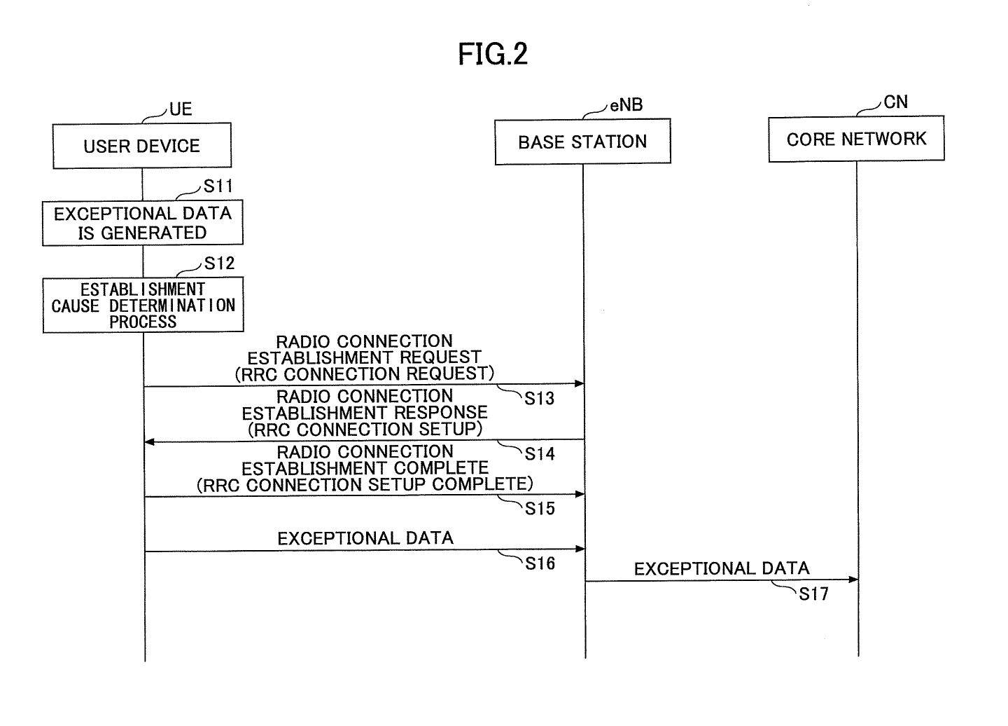

FIG. 2 is a sequence chart illustrating a process performed by the radio communication system of the present embodiment. First, the user device UE detects that “high-emergency important data” (which is hereafter referred to as “exceptional data”) to be transmitted to the predetermined access point name (APN) has been generated (S11). For example, this process may be performed when the user device UE, which is a gas meter, detects a gas leak and reports the gas leak to a server of a gas company.

Next, the user device UE determines that an establishment cause indicating transmission of the exceptional data needs to be set in a radio connection establishment request (RRC connection request) to be transmitted to the base station eNB (S12). Next, the user device UE transmits, to the base station eNB, the radio connection establishment request where the establishment cause determined at step S12 is set (S13).

When receiving the radio connection establishment request, the base station eNB recognizes that the exceptional data is to be transmitted by referring to the establishment cause set in the radio connection establishment request, determines that an RRC connection needs to be established with the user device UE in preference to other user devices UE, and transmits a radio connection establishment response (RRC connection setup) to the user device UE (S14). The user device UE transmits a radio connection establishment complete (RRC connection setup complete) to the base station eNB (S15).

Next, the user device UE establishes a bearer with the core network CN for communication with the predetermined APN, and transmits the exceptional data via the base station eNB to the core network CN (S16, S17).

### FUNCTIONAL CONFIGURATIONS

### User Device

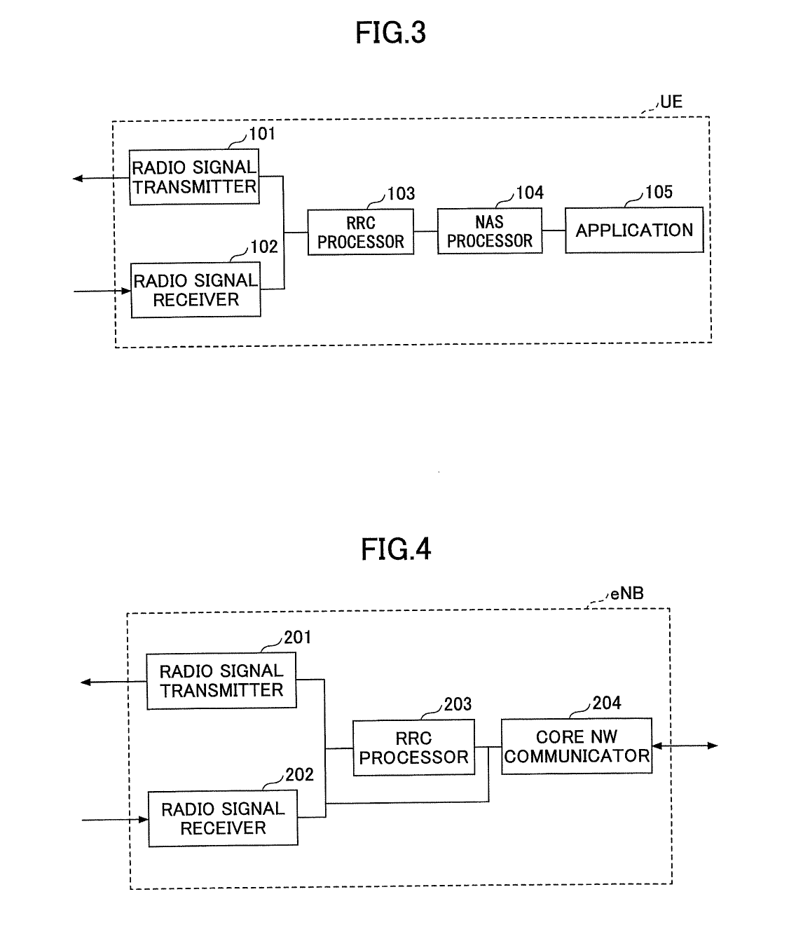

FIG. 3 is a drawing illustrating an example of a functional configuration of a user device according to an embodiment. As illustrated by FIG. 3, the user device UE includes a radio signal transmitter 101, a radio signal receiver 102, an RRC processor 103, a NAS processor 104, and an application 105. FIG. 3 illustrates only functional components of the user device UE that are particularly relevant to the present embodiment, and the user device UE may also at least include unshown functional components that are necessary for operations conforming to LTE. Also, the functional configuration of FIG. 3 is just an example. As long as operations related to the present embodiment can be performed, the categorization and the names of the functional components may be freely changed.

The radio signal transmitter 101 includes a function to generate various signals to be transmitted from the user device UE, and to wirelessly transmit the generated signals. The radio signal receiver 102 includes a function to receive radio signals from the base station eNB. It is assumed (as a non-limiting example) that each of the radio signal transmitter 101 and the radio signal receiver 102 includes a packet buffer and performs processes in the layer 1 (PHY) and the layer 2 (MAC, RLC, PCP).

The RRC processor 103 includes a function to perform various processes related to the RRC layer such as status management of the RRC layer, generation of RRC messages, and transmission and reception of RRC messages to and from the base station eNB. Also, the RRC processor 103 transmits and receives RRC messages to and from the base station eNB via the radio signal transmitter 101 and the radio signal receiver 102.

The NAS processor 104 includes a function to perform various processes related to the NAS layer such as status management of the NAS layer and generation of NAS messages. Also, the NAS processor 104 transmits and receives NAS messages to and from the core network via the radio signal transmitter 101 and the radio signal receiver 102. Also, when transmitting a NAS message, the NAS processor 104 requests the RRC processor 103 to establish an RRC connection. Also, when requesting the RRC processor 103 to establish an RRC connection, the NAS processor 104 determines an establishment cause to be set in an RRC message, and reports the determined establishment cause to the RRC processor 103.

Also, the NAS processor 104 includes a function to determine whether the user device UE itself is set at low access priority, and to determine whether data to be transmitted to the base station eNB is high-priority data (exceptional data). Also, the NAS processor 104 includes a function to determine whether a destination APN is set at low access priority. The NAS processor 104 performs determination processes and therefore may be referred to as a “determiner”.

Also, when the user device UE itself is set at low access priority and data to be transmitted to the base station eNB is high-priority data (exceptional data), the NAS processor 104 reports, to the RRC processor 103, information indicating that the high-priority data (exceptional data) is to be transmitted.

The application 105 is an application that runs on an operation system (OS) of the user device UE. The application 105 generates data to be transmitted to, for example, an external network, and inputs the generated data to the NAS processor 104. Also, when inputting the generated data to the NAS processor 104, the application 105 reports, to the NAS processor 104, whether the data is high-priority data (exceptional data).

### Base Station

FIG. 4 is a drawing illustrating an example of a functional configuration of a base station according to an embodiment. As illustrated by FIG. 4, the base station eNB includes a radio signal transmitter 201, a radio signal receiver 202, an RRC processor 203, and a core NW communicator 204. FIG. 4 illustrates only functional components of the base station eNB that are particularly relevant to the present embodiment, and the base station eNB may also at least include unshown functional components that are necessary for operations conforming to LTE. Also, the functional configuration of FIG. 4 is just an example. As long as operations related to the present embodiment can be performed, the categorization and the names of the functional components may be freely changed.

The radio signal transmitter 201 includes a function to generate various physical layer signals from upper layer signals to be transmitted from the base station eNB, and to wirelessly transmit the physical layer signals. The radio signal receiver 202 includes a function to wirelessly receive various signals from the user device UE, and obtain upper layer signals from the received physical layer signals.

It is assumed (as a non-limiting example) that each of the radio signal transmitter 201 and the radio signal receiver 202 includes a packet buffer and performs processes in the layer 1 (PHY) and the layer 2 (MAC, RLC, PCP).

The RRC processor 203 includes a function to perform various processes related to the RRC layer such as status management of the RRC layer, generation of RRC messages, and transmission and reception of RRC messages to and from the user device UE. Also, the RRC processor 203 determines whether to establish an RRC connection with the user device UE based on an establishment cause set in an RRC message received from the user device UE.

The core NW communicator 204 includes a function to transmit and receive C-plane and U-plane data to and from the core network CN.

The entire functional configuration of each of the user device UE and the base station eNB described above may be implemented by a hardware circuit(s) (e.g., one or more IC chips). Alternatively, a part of the functional configuration may be implemented by a hardware circuit(s) and the remaining part of the functional configuration may be implemented by a CPU and programs.

### User Device

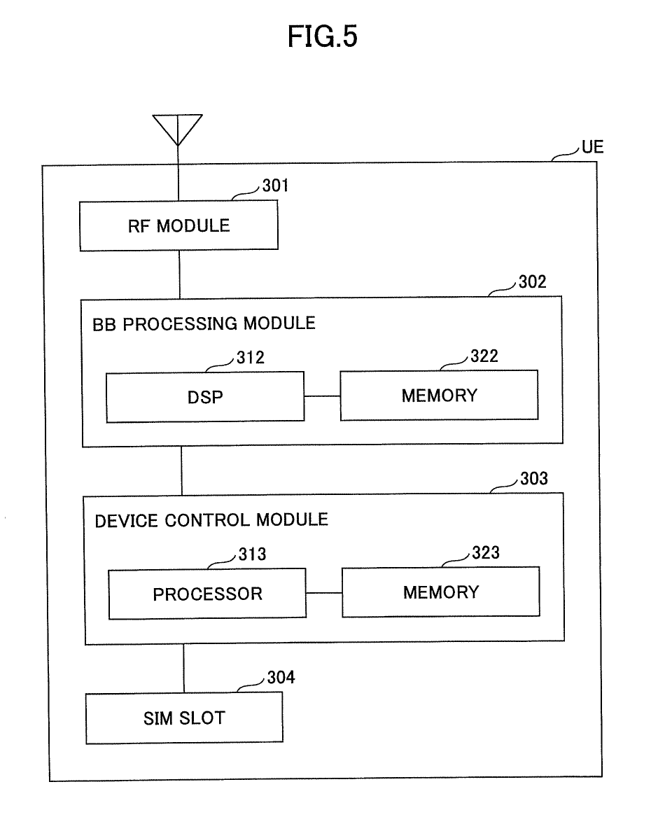

FIG. 5 is a drawing illustrating an example of a hardware configuration of a user device according to an embodiment. FIG. 5 illustrates a configuration that is closer than FIG. 3 to an actual implementation. As illustrated by FIG. 5, the user device UE includes a radio frequency (RF) module 301 that performs processes related to radio signals, a baseband (BB) processing module 302 that performs baseband signal processing, a UE control module 303 that performs processes in upper layers, and a SIM slot 304 that is an interface for accessing a SIM card.

The RF module 301 performs processes such as digital-to-analog (D/A) conversion, modulation, frequency conversion, and power amplification on a digital baseband signal received from the BB processing module 302 to generate a radio signal to be transmitted from an antenna. Also, the RF module 301 performs processes such as frequency conversion, analog-to-digital (A/D) conversion, and demodulation on a received radio signal to generate a digital baseband signal, and sends the digital baseband signal to the BB processing module 302. The RF module 301 may include, for example, a part of the radio signal transmitter 101 and a part of the radio signal receiver 102 in FIG. 3.

The BB processing module 302 converts an IP packet into a digital baseband signal and vice versa. A digital signal processor (DSP) 312 is a processor that performs signal processing in the BB processing module 302. A memory 322 is used as a work area of the DSP 312. The BB processing module 302 may include, for example, a part of the radio signal transmitter 101 and a part of the radio signal receiver 102 in FIG. 3.

The UE control module 303 performs protocol processing in the IP layer and processes related to applications. A processor 313 performs processes of the UE control module 303. A memory 323 is used as a work area of the processor 313. The processor 313 also reads and writes data from and to a SIM via the SIM slot 304. The UE control module 303 may include, for example, the RRC processor 103, the NAS processor 104, and the application 105 in FIG. 3.

### Base Station

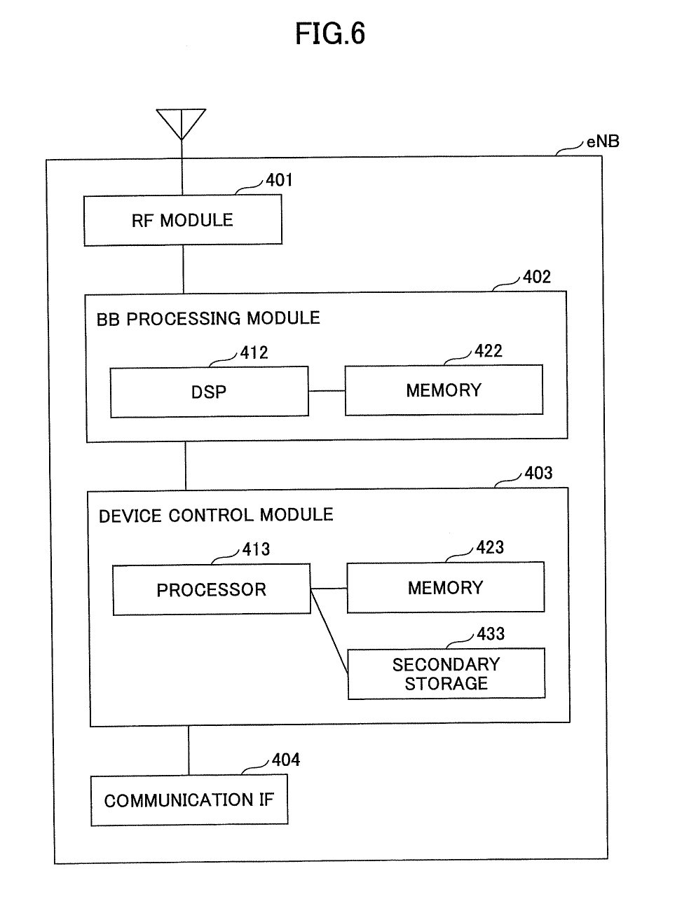

FIG. 6 is a drawing illustrating an example of a hardware configuration of a base station according to an embodiment. FIG. 6 illustrates a configuration that is closer than FIG. 4 to an actual implementation. As illustrated by FIG. 6, the base station eNB includes an RF module 401 that performs processes related to radio signals, a BB processing module 402 that performs baseband signal processing, a device control module 403 that performs processes in upper layers, and a communication IF 404 that is an interface for connecting with a network.

The RF module 401 performs processes such as D/A conversion, modulation, frequency conversion, and power amplification on a digital baseband signal received from the BB processing module 402 to generate a radio signal to be transmitted from an antenna. Also, the RF module 401 performs processes such as frequency conversion, A/D conversion, and demodulation on a received radio signal to generate a digital baseband signal, and sends the digital baseband signal to the BB processing module 402. The RF module 401 may include, for example, a part of the radio signal transmitter 201 and a part of the radio signal receiver 202 in FIG. 4.

The BB processing module 402 converts an IP packet into a digital baseband signal and vice versa. A DSP 412 is a processor that performs signal processing in the BB processing module 402. A memory 422 is used as a work area of the DSP 412. The BB processing module 402 may include, for example, a part of the radio signal transmitter 201 and a part of the radio signal receiver 202 in FIG. 4.

The device control module 403 performs protocol processing in the IP layer and operation and maintenance (OAM) processing. A processor 413 performs processes of the device control module 403. A memory 423 is used as a work area of the processor 413. A secondary storage 433 is, for example, an HDD and stores various settings for operations of the base station eNB itself. The device control module 403 may include, for example, the RRC processor 203 in FIG. 4. The communication IF 404 may include, for example, the core NW communicator 204 in FIG. 4.

### PROCESSES

Next, processes (1) through (3) performed by the user device UE of the present embodiment are described. Each of the user device UE and the base station eNB may include functions for performing all or a part of the processes (1) through (3) described below. Also, the user device UE and the base station eNB may be configurable to perform one or more of the processes (1) through (3).

### Process (1)

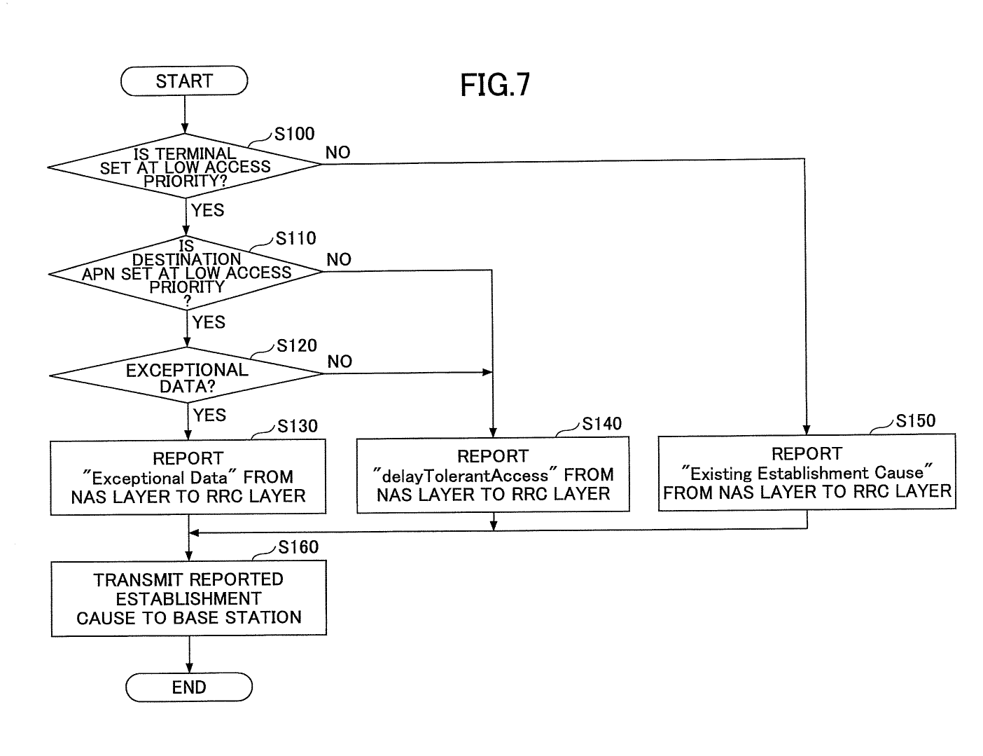

FIG. 7 is a flowchart illustrating the process (1). FIG. 7 illustrates a process that is performed by the application 105 of the user device UE when data to be transmitted to the predetermined APN is generated.

At step S100, the NAS processor 104 refers to an internal memory of the user device UE or a SIM inserted into the user device UE and thereby determines whether the user device UE is set at low access priority. When the user device UE is set at low access priority, the NAS processor 104 proceeds to step S110; and when the user device UE is not set at low access priority (i.e., when the user device UE is a normal user device), the NAS processor 104 proceeds to step S150.

At step S110, the NAS processor 104 refers to an internal memory of the user device UE or a SIM inserted into the user device UE and thereby determines whether a destination APN is set at low access priority. When the destination APN is set at low access priority, the NAS processor 104 proceeds to step S120; and when the destination APN is not set at low access priority, the NAS processor 104 proceeds to step S140.

At step S120, the NAS processor 104 determines whether the application 105 has reported that the data to be transmitted to the predetermined APN is “exceptional data”. When it has been reported that the data is “exceptional data”, the NAS processor 104 proceeds to step S130; and when it has not been reported that the data is “exceptional data” (i.e., when it has been reported that the data is normal data), the NAS processor 104 proceeds to step S140.

At step S130, the NAS processor 104 reports “Exceptional Data” to the RRC processor 103 as an establishment cause to be set in an RRC connection request. Here, “Exceptional Data” is an establishment cause newly defined by the present embodiment and indicates that it is necessary to request establishment of an RRC connection to transmit exceptional data.

At step S140, the NAS processor 104 reports “delayTolerantAccess” to the RRC processor 103 as an establishment cause to be set in an RRC connection request.

At step S150, the NAS processor 104 reports “existing establishment cause” to the RRC processor 103 as an establishment cause to be set in an RRC connection request.

At step S160, the RRC processor 103 sets the establishment cause reported from the NAS processor 104 in a radio connection establishment request (RRC connection request), and transmits the radio connection establishment request to the base station eNB.

The process (1) is described above. Here, at step S110 of the process (1), there may be a case where information indicating whether the APN is set at low access priority is not explicitly stored in the internal memory of the user device UE nor the SIM inserted into the user device UE. For this reason, step S110 may be omitted, and the NAS processor 104 may be configured to implicitly determine that the destination APN is set at low access priority.

### Variation of Process (1)

Next, a variation of the process (1) is described. In the process (1) described with reference to FIG. 7, “Exceptional Data” indicating transmission of exceptional data is transmitted to the base station eNB when the user device UE itself is set at low access priority and the destination APN is also set at low access priority. That is, when one of the user device UE and the destination APN is not set at low access priority, “Exceptional Data” is not transmitted to the base station eNB.

However, taking into account of the development of IoT, it is expected that even a normal user device UE may transmit data that is more urgent than normal data transmission related to, for example, Web browsing. For this reason, in the present embodiment, even a normal user device UE not set at low access priority may be allowed to transmit “Exceptional Data” to the base station eNB.

Similarly, there may be a case where it is preferable to allow the user device UE to explicitly report transmission of exceptional data to the base station eNB even when the destination APN is not set at low access priority (i.e., when the user device UE itself is not set at low access priority). For this reason, in the present embodiment, the user device UE may be allowed to transmit “Exceptional Data” to the base station eNB even when the APN is not set at low access priority.

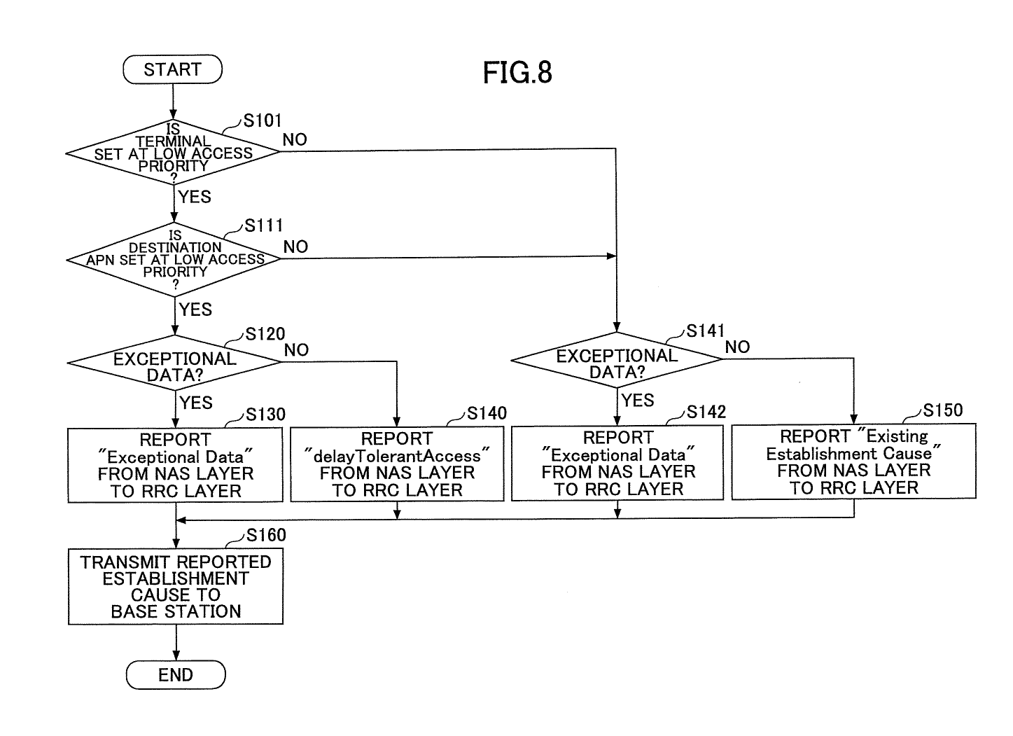

FIG. 8 is a flowchart illustrating a variation of the process (1). The same reference numbers are assigned to the same steps in FIGS. 7 and 8, and the descriptions of those steps are omitted here.

At step S101, the NAS processor 104 refers to an internal memory of the user device UE or a SIM inserted into the user device UE and thereby determines whether the user device UE is set at low access priority. When the user device UE is set at low access priority, the NAS processor 104 proceeds to step S111; and when the user device UE is not set at low access priority (i.e., when the user device UE is a normal user device), the NAS processor 104 proceeds to step S141.

At step S111, the NAS processor 104 refers to an internal memory of the user device UE or a SIM inserted into the user device UE and thereby determines whether a destination APN is set at low access priority. When the destination APN is set at low access priority, the NAS processor 104 proceeds to step S120; and when the destination APN is not set at low access priority, the NAS processor 104 proceeds to step S141.

At step S141, the NAS processor 104 determines whether the application 105 has reported that data to be transmitted to the predetermined APN is “exceptional data”. When it has been reported that the data is “exceptional data”, the NAS processor 104 proceeds to step S142; and when it has not been reported that the data is “exceptional data” (i.e., when it has been reported that the data is normal data), the NAS processor 104 proceeds to step S150.

At step S142, the NAS processor 104 reports “Exceptional Data” to the RRC processor 103 as an establishment cause to be set in an RRC connection request.

### Process (2)

In the process (1), transmission of exceptional data is reported from the user device UE to the base station eNB by using the newly-defined establishment cause. However, in the current LTE, only one more establishment cause can be newly defined. Therefore, considering the future expansion, it is preferable to enable the user device UE to report transmission of exceptional data to the base station eNB without newly defining an establishment cause. For this reason, in the process (2), information (which is hereafter referred to as “exceptional data identifier”) indicating transmission of exceptional data is reported from the user device UE to the base station eNB separately from the establishment cause. The “exceptional data identifier” may be represented by 1 bit. For example, “0 (or 1)” may indicate normal data, and “1 (or 0)” may indicate exceptional data.

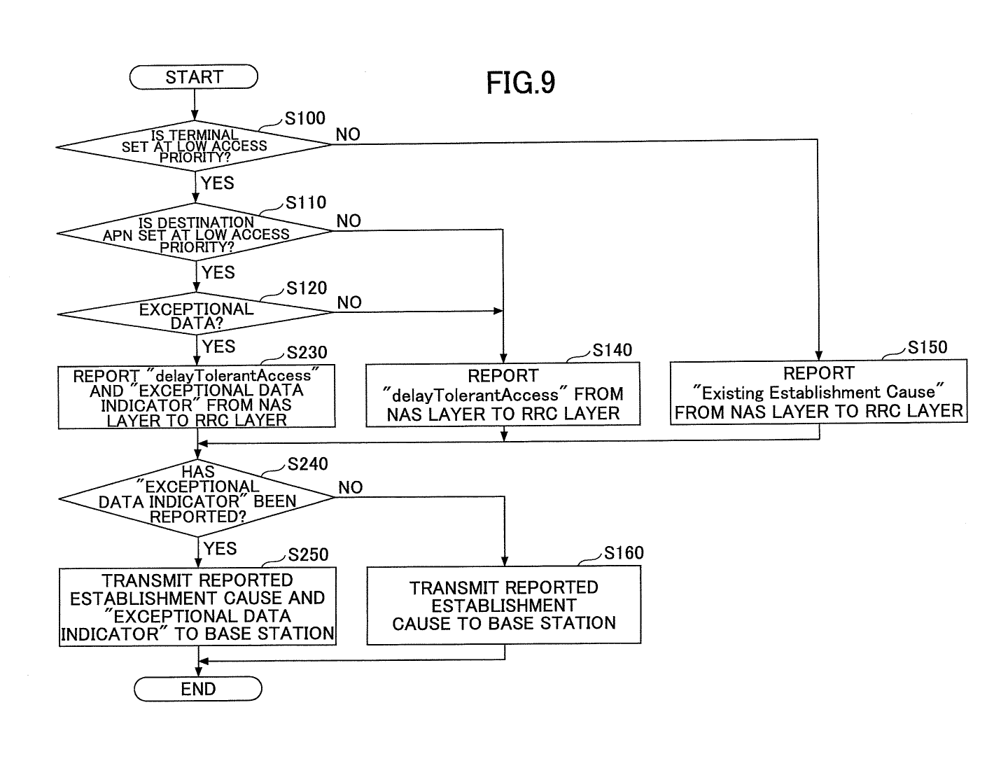

FIG. 9 is a flowchart illustrating the process (2). The same reference numbers are assigned to the same steps in FIGS. 7 and 9, and the descriptions of those steps are omitted here.

At step S230, the NAS processor 104 reports “delayTolerantAccess” to the RRC processor 103 as an establishment cause to be set in an RRC connection request, and also reports an “exceptional data identifier” to the RRC processor 103.

At step S240, the RRC processor 103 determined whether the “exceptional data identifier” has been reported from the NAS processor 104. When the “exceptional data identifier” has been reported from the

NAS processor 104, the RRC processor 103 proceeds to step S250; and when the “exceptional data identifier” has not been reported from the NAS processor 104, the RRC processor 103 proceeds to step S160.

At step S250, the RRC processor 103 sets the establishment cause and the “exceptional data identifier” reported from the NAS processor 104 in a radio connection establishment request (RRC connection request), and transmits the radio connection establishment request to the base station eNB.

Here, the RRC processor 103 may be configured to set only the establishment cause reported from the NAS processor 104 in the radio connection establishment request (RRC connection request), and set the “exceptional data identifier” in a radio connection establishment complete (RRC connection setup complete) to be transmitted to the base station eNB. In this case, the base station eNB may be configured to first establish an RRC connection with the user device UE by performing steps up to the radio connection establishment complete, and to release the RRC connection established with the user device UE when the “exceptional data identifier” is not set and the processing load of the base station eNB is high.

The process (2) is described above. The process (2) makes it possible to report, to the base station eNB, that a radio connection establishment request (RRC connection request) is for transmission of exceptional data without consuming the remaining resource usable to define a new establishment cause.

### Variation of Process (2)

Next, a variation of the process (2) is described. Similarly to the variation of the process (1), the process (2) may be modified to allow even a normal user device UE not set at low access priority to transmit “exceptional data identifier” to the base station eNB.

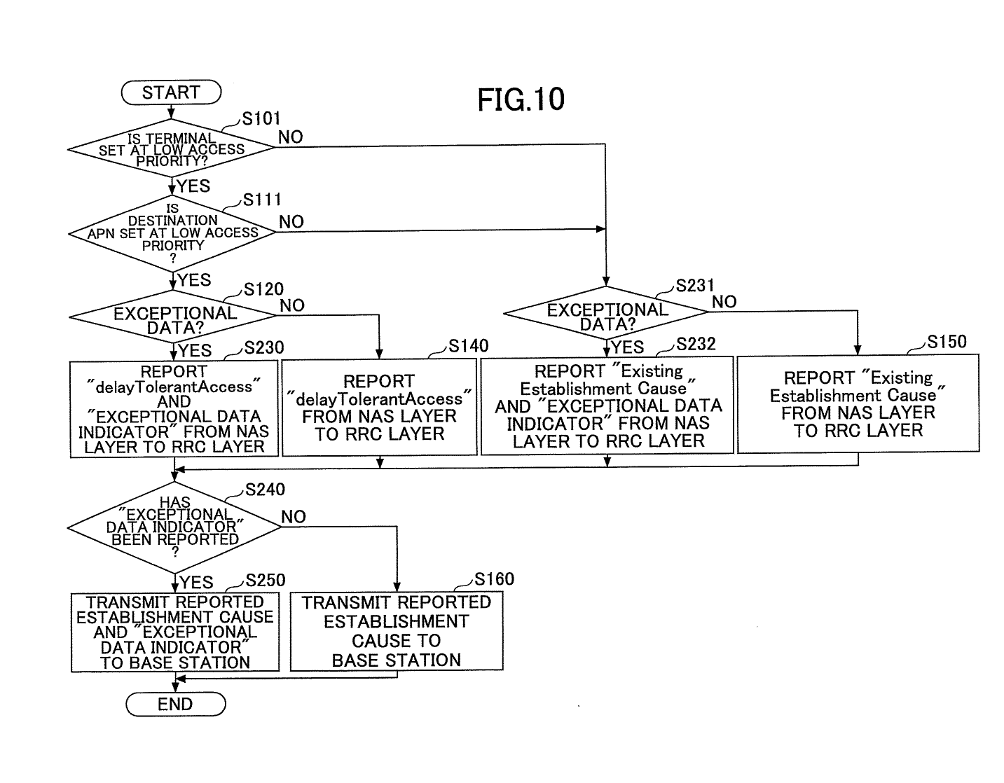

FIG. 10 is a flowchart illustrating a variation of the process (2). The same reference numbers are assigned to the same steps in FIGS. 7 through 10, and the descriptions of those steps are omitted here.

At step S231, the NAS processor 104 determines whether the application 105 has reported that data to be transmitted to the predetermined APN is “exceptional data”. When it has been reported that the data is “exceptional data”, the NAS processor 104 proceeds to step S232; and when it has not been reported that the data is “exceptional data” (i.e., when it has been reported that the data is normal data), the NAS processor 104 proceeds to step S150.

At step S232, the NAS processor 104 reports “existing establishment cause” to the RRC processor 103 as an establishment cause to be set in an RRC connection request, and also reports the “exceptional data identifier” to the RRC processor 103.

### Process (3)

In the process (2), information (which is hereafter referred to as “exceptional data identifier”) indicating transmission of exceptional data is reported from the user device UE to the base station eNB separately from the establishment cause.

Here, as described above, the existing establishment causes include “emergency” that is set when the user device UE performs an emergency call. An emergency call is a call to an emergency service (e.g., police or a fire department), and data communication (except an emergency call via VoLTE) is not an emergency call. Therefore, according to the specification of the current LTE, “emergency” is not set for data communication. The process (3) allows the user device UE to set “emergency” as an establishment cause in a radio connection establishment request for transmission of exceptional data and thereby request the base station eNB to preferentially handle the radio connection establishment request.

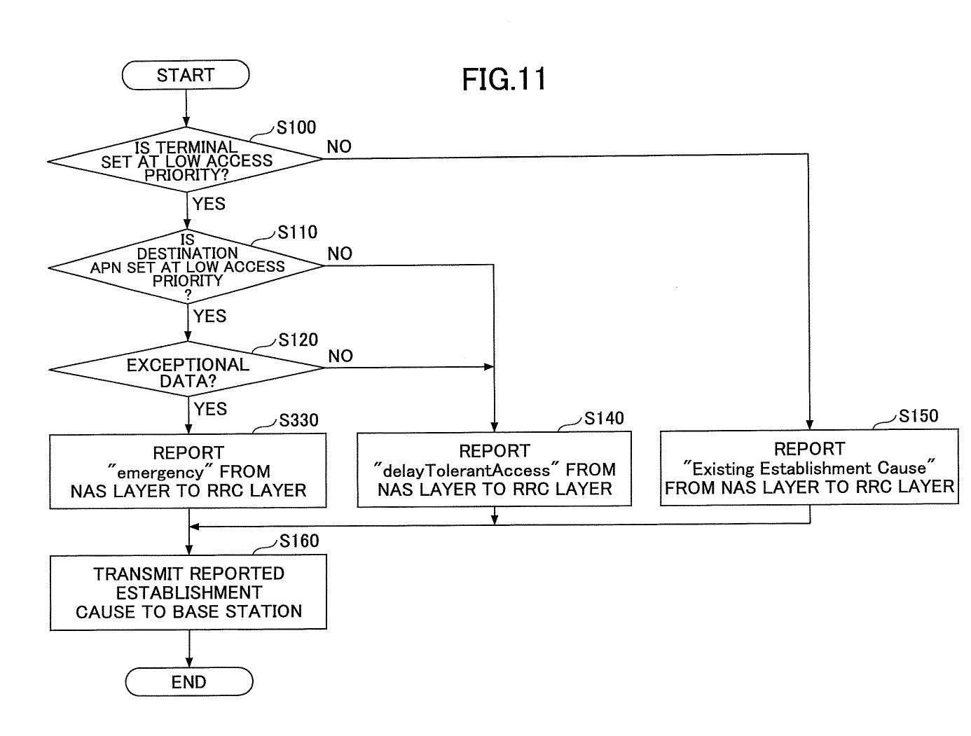

FIG. 11 is a flowchart illustrating the process (3). The same reference numbers are assigned to the same steps in FIGS. 7 through 11, and the descriptions of those steps are omitted here.

At step S330, the NAS processor 104 reports “emergency” to the RRC processor 103 as an establishment cause to be set in an RRC connection request.

### Variation of Process (3)

Next, a variation of the process (3) is described. Similarly to the variation of the process (1) and the variation of process (2), the process (3) may be modified to allow even a normal user device UE not set at low access priority to transmit “emergency” to the base station eNB.

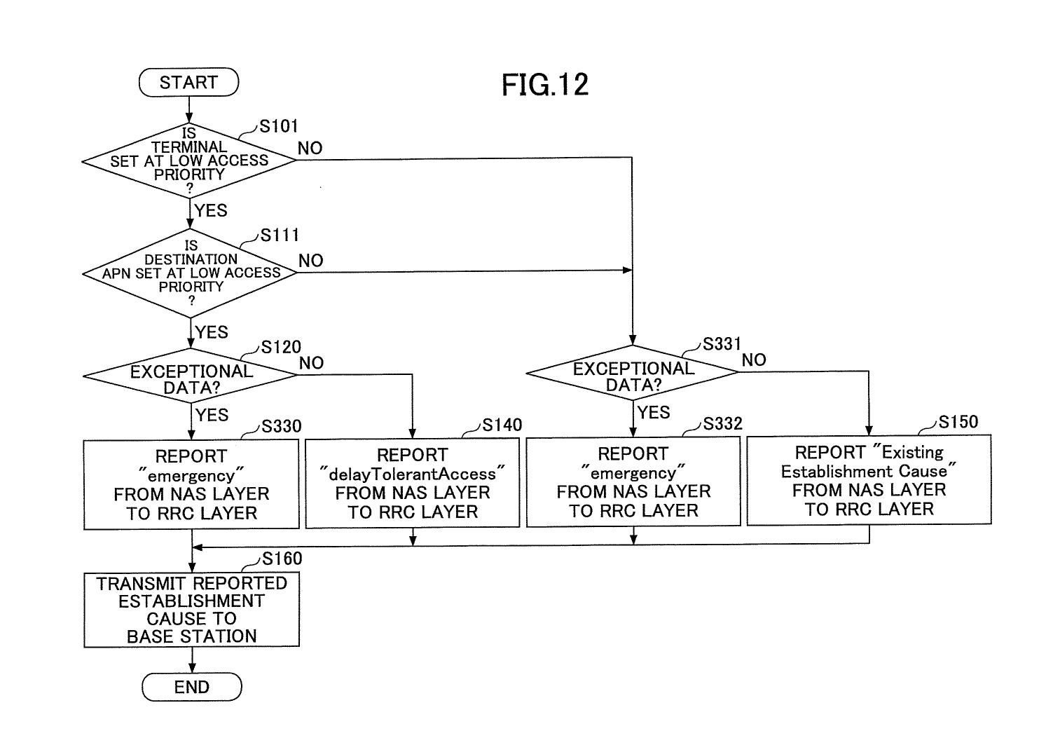

FIG. 12 is a flowchart illustrating a variation of the process (3). The same reference numbers are assigned to the same steps in FIGS. 7 through 12, and the descriptions of those steps are omitted here.

At step S331, the NAS processor 104 determines whether the application 105 has reported that data to be transmitted to the predetermined APN is “exceptional data”. When it has been reported that the data is “exceptional data”, the NAS processor 104 proceeds to step S332; and when it has not been reported that the data is “exceptional data” (i.e., when it has been reported that the data is normal data), the NAS processor 104 proceeds to step S150.

At step S332, the NAS processor 104 reports “emergency” to the RRC processor 103 as an establishment cause to be set in an RRC connection request.

The process (3) is described above. The process (3) makes it possible to request the base station eNB to preferentially handle a radio connection establishment request using an existing establishment cause without consuming the remaining resource usable to define a new establishment cause and without defining a new identifier to be set in a radio connection establishment message.

### SUMMARY

The above embodiment provides a user device communicating with a base station. The user device includes a determiner that determines whether the user device is set at low access priority and whether data to be transmitted to the base station is high-priority data, and a transmitter that transmits an RRC message to the base station. When the user device is set at low access priority and the data to be transmitted to the base station is the high-priority data, the determiner reports, to the transmitter, information indicating transmission of the high-priority data, and the transmitter sets the information indicating the transmission of the high-priority data in the RRC message, and transmits the RRC message to the base station. This user device UE provides a technology that enables even a user device with low access priority to transmit high-priority data.

The information indicating the transmission of the high-priority data may be an establishment cause indicating the high-priority data. In this case, the transmitter may set the establishment cause indicating the high-priority data in an RRC connection request message, and transmit the RRC connection request message to the base station. With this configuration, the user device UE can report, to the base station eNB, that the establishment of an RRC connection is requested for transmission of high-priority data. Also, this configuration enables the base station eNB with a high load to handle an RRC connection request from the user device UE of the present embodiment in preference to an RRC connection request from a normal user device UE.

The information indicating the transmission of the high-priority data may be different from an establishment cause to be set in an RRC connection request message. In this case, the transmitter may set the information indicating the transmission of the high-priority data and the establishment cause indicating delay tolerance in the RRC connection request message, and transmit the RRC connection request message to the base station. This configuration allows the user device UE to report, to the base station eNB, that the establishment of an RRC connection is requested for transmission of high-priority data without consuming the remaining resource usable to define a new establishment cause. Also, this configuration also enables the base station eNB with a high load to preferentially establish an RRC connection with the user device UE of the present embodiment.

The information indicating the transmission of the high-priority data may be different from an establishment cause to be set in an RRC connection request message. In this case, the transmitter may set the establishment cause indicating delay tolerance in the RRC connection request message and transmit the RRC connection request message to the base station. Also, in this case, the transmitter may set the information indicating the transmission of the high-priority data in an RRC connection setup complete message and transmit the RRC connection setup complete message to the base station. This configuration allows the user device UE to report, to the base station eNB, that the establishment of an RRC connection is requested for transmission of high-priority data without consuming the remaining resource usable to define a new establishment cause. Also, this configuration enables the base station eNB with a high load to preferentially establish an RRC connection with the user device UE of the present embodiment.

The information indicating the transmission of the high-priority data may be an establishment cause for an emergency call, and the transmitter may set the establishment cause for the emergency call in an RRC connection request message and transmit the RRC connection request message to the base station. This configuration allows the user device UE to report, to the base station eNB, that the establishment of an RRC connection is requested for transmission of high-priority data without consuming the remaining resource usable to define a new establishment cause and without defining a new identifier to be set in a radio connection establishment message.

Also, when the user device is not set at low access priority and the data to be transmitted to the base station is high-priority data, the determiner may report, to the transmitter, the information indicating the transmission of the high-priority data. This configuration enables even a normal user device UE to report, to the base station eNB, that the establishment of an RRC connection is requested for transmission of high-priority data.

The above embodiment also provides a communication method performed by a user device communicating with a base station. The communication method includes determining whether the user device is set at low access priority and whether data to be transmitted to the base station is high-priority data; and when the user device is set at low access priority and the data to be transmitted to the base station is the high-priority data, setting information indicating transmission of the high-priority data in an RRC message, and transmitting the RRC message to the base station. This communication method provides a technology that enables even a user device with low access priority to transmit high-priority data.

### SUPPLEMENTARY DESCRIPTION OF EMBODIMENTS

Components of each apparatus (the user device UE, the base station eNB) described in the above embodiments may be implemented by executing a program stored in a memory by a CPU (processor) of the apparatus, may be implemented by hardware such as hardware circuits including logic for the above-described processes, or may be implemented by a combination of programs and hardware.

Embodiments of the present invention are described above. However, the present invention is not limited to the above-described embodiments, and a person skilled in the art may understand that variations, modifications, and replacements may be made to the above embodiments. Although specific values are used in the above descriptions to facilitate the understanding of the present invention, the values are just examples and other appropriate values may also be used unless otherwise mentioned. Grouping of subject matter in the above descriptions is not essential for the present invention. For example, subject matter described in two or more sections may be combined as necessary, and subject matter described in one section may be applied to subject matter described in another section unless they contradict each other. Boundaries of functional units or processing units in functional block diagrams do not necessarily correspond to boundaries of physical components. Operations of multiple functional units may be performed by one physical component, and an operation of one functional unit may be performed by multiple physical components. The order of steps in sequence charts and flowcharts described in the embodiments may be changed unless they do not become inconsistent. Although functional block diagrams are used to describe the user device UE and the base station eNB, the user device UE and the base station eNB may be implemented by hardware, software, or a combination of them. Software to be executed by a processor of the user device UE and software to be executed by a processor of the base station eNB according to the embodiments of the present invention may be stored in any appropriate storage medium such as a random access memory (RAM), a flash memory, a read-only memory (ROM), an EPROM, an EEPROM, a register, a hard disk drive (HDD), a removable disk, a CD-ROM, a database, or a server.

The NAS processor 104 is an example of a determiner. A combination of the radio signal transmitter 101 and the RRC processor 103 is an example of a transmitter. “Exceptional Data” and “exceptional data identifier” are examples of information indicating high-priority data is to be transmitted.

The present application is based on and claims the benefit of priority of Japanese Patent Application No. 2016-022798 filed on Feb. 9, 2016, the entire contents of which are hereby incorporated herein by reference.

### EXPLANATION OF REFERENCE NUMERALS

UE User device
eNB Base station
101 Radio signal transmitter
102 Radio signal receiver
103 RRC processor
104 NAS processor
105 Application
201 Radio signal transmitter
202 Radio signal receiver
203 RRC processor
204 Core NW communicator
301 RF module
302 BB processing module
303 UE control module
304 SIM slot
401 RF module
402 BB processing module
403 Device control module
404 Communication IF

1. A user device communicating with a base station, the user device comprising:
a determiner that determines whether the user device is set at low access priority and whether data to be transmitted to the base station is high-priority data;
a transmitter that transmits an RRC message to the base station,
wherein when the user device is set at low access priority and the data to be transmitted to the base station is the high-priority data,
the determiner reports, to the transmitter, information indicating transmission of the high-priority data, and
the transmitter sets the information indicating the transmission of the high-priority data in the RRC message, and transmits the RRC message to the base station.

2. The user device as claimed in claim 1, wherein
the information indicating the transmission of the high-priority data is an establishment cause indicating the high-priority data; and
the transmitter sets the establishment cause indicating the high-priority data in an RRC connection request message, and transmits the RRC connection request message to the base station.

3. The user device as claimed in claim 1, wherein
the information indicating the transmission of the high-priority data is different from an establishment cause to be set in an RRC connection request message; and
the transmitter sets the information indicating the transmission of the high-priority data and the establishment cause indicating delay tolerance in the RRC connection request message, and transmits the RRC connection request message to the base station.

4. The user device as claimed in claim 1, wherein
the information indicating the transmission of the high-priority data is different from an establishment cause to be set in an RRC connection request message;
the transmitter sets the establishment cause indicating delay tolerance in the RRC connection request message and transmits the RRC connection request message to the base station; and
the transmitter sets the information indicating the transmission of the high-priority data in an RRC connection setup complete message and transmits the RRC connection setup complete message to the base station.

5. The user device as claimed in claim 1, wherein
the information indicating the transmission of the high-priority data is an establishment cause for an emergency call; and
the transmitter sets the establishment cause for the emergency call in an RRC connection request message, and transmits the RRC connection request message to the base station.

6. A communication method performed by a user device communicating with a base station, the communication method comprising:
determining whether the user device is set at low access priority and whether data to be transmitted to the base station is high-priority data; and
when the user device is set at low access priority and the data to be transmitted to the base station is the high-priority data, setting information indicating transmission of the high-priority data in an RRC message, and transmitting the RRC message to the base station.
